(19) United States
(12) Patent Application Publication
(10) Pub. No.: US 2026/0129139 A1
(43) Pub. Date: May 7, 2026

(54) CONTEXT-AWARE VOICE CONTROL OF LIVE VIDEO PRODUCTION

(71) Applicant: ROSS VIDEO LIMITED, Iroquois (CA)

(72) Inventors: Robert CORDLE, III, Green Cove Springs, FL (US); Troy ENGLISH, Ottawa (CA); Wojciech Marek TRYC, Ottawa (CA)

(21) Appl. No.: 19/379,310

(22) Filed: Nov. 4, 2025

Related U.S. Application Data
(60) Provisional application No. 63/715,968, filed on Nov. 4, 2024.

(51) Int. Cl. H04N 5/222; G10L 15/08; G10L 15/18; G10L 15/22; H04N 21/2187

(52) U.S. Cl. CPC H04N 5/222; G10L 15/1815; G10L 15/1822; G10L 15/22; H04N 21/2187; G10L 2015/088; G10L 2015/223

(57) ABSTRACT

For context-aware voice control of live video production, a stream of speech that is related to a live video production is received, during that live video production. A control output to change an aspect of the live video production is provided based on a trigger element in the stream of speech and also a context of the live video production at a time of receipt of the trigger element in the stream of speech.

### CROSS-REFERENCE TO RELATED APPLICATION

The present application is related to, and claims the benefit of, U.S. provisional patent application Ser. No. 63/715,968, entitled “CONTEXT-AWARE VOICE CONTROL OF LIVE VIDEO PRODUCTION”, filed on Nov. 4, 2024, the entire contents of which are hereby incorporated by reference.

### FIELD

The present disclosure relates generally to equipment and methods for live video production control, and in particular, to context-aware voice control of live video production.

### BACKGROUND

Realtime control responsiveness is especially important in media applications such as live video productions. Delays in changing content during a live video broadcast, for example, are quite noticeable when on-air commentary becomes out of sync with video or graphics that are displayed.

In a live news broadcast, for example, production operators may need to schedule or anticipate live video production changes to reduce delays between when certain content is needed and when that content is available for output. Pre-scheduling may be effective as long as production flow remains on schedule and there are no unexpected developments, but this is rarely the case in live video production. In a live football sportscast, for example, it is impossible to predict a team or participant that may score or where (locally or otherwise) other developments that may be of interest may take place. In this example, when focus is to shift to a scoring team or player or to a different location at which developments may be of interest, production staff have to identify, locate, and deploy appropriate content, which takes time and can result in noticeable delay during a live broadcast.

In a manual control scenario, a production crew is responsible for production control, which inherently involves delays as a crew member determines a control action that is to be taken and initiates that action. To the extent that some level of control automation is available, in the case of ambiguity in an input such as a county name that is used in multiple states, either the ambiguity must be resolved by operator intervention or the ambiguity causes an error by initiating multiple competing actions or not initiating any action, all of which result in delay.

There remains a need for more responsive control of live video production.

### SUMMARY

Embodiments disclosed herein may enable realtime, context-aware control of a live video production or production environment, via voice control. In some embodiments, speech is parsed and monitored to identify certain keywords or commands, and a live production is controlled based on not only an identified keyword or command, but also the context of the production when an identified keyword or command was spoken. This type of control can significantly reduce or avoid noticeable delay between a time at which content is needed and a time at which that content can be made available, thereby providing substantial improvements in live video production control and quality.

Context-aware voice control as disclosed herein may facilitate dynamic adjustments in live broadcasts, for example, and/or in other live production scenarios.

A context-aware approach to voice control may be particularly advantageous in managing ambiguous voice commands. Such ambiguity is common in live production scenarios. In fast-paced environments such as sports broadcasting, where rapid transitions and real-time reactions are preferred, voice control systems may struggle to distinguish between commands with similar or overlapping keywords such as “Tigers” referring to different sports teams or “Washington” referring to various geographic locations. By incorporating contextual analysis as disclosed herein, such as active geographic focus, visual content currently displayed, or time-based cues, ambiguities may be effectively resolved without manual intervention. This may enable more accurate, instantaneous command execution, and allow production teams to operate smoothly even under unpredictable, high-pressure conditions. Such context-awareness may help ensure that only relevant control actions are triggered, thereby potentially reducing latency and enhancing precision of live video production control.

One aspect of the present disclosure relates to video production control equipment that includes an interface and a controller. The interface is to receive, during a live video production, a stream of speech that is related to the live video production. The controller is coupled to the interface, to provide a control output to change an aspect of the live video production, based on a trigger element in the stream of speech and a context of the live video production at a time of receipt of the trigger element in the stream of speech.

Another aspect of the present disclosure relates to a method that involves: receiving, during a live video production, a stream of speech that is related to the live video production; and providing a control output to change an aspect of the live video production. The control output is based on a trigger element in the stream of speech and a context of the live video production at a time of receipt of the trigger element in the stream of speech.

A non-transitory processor-readable medium is also disclosed, and stores instructions which, when executed by a processor, cause the processor to receive, during a live video production, a stream of speech that is related to the live video production; and provide a control output to change an aspect of the live video production based on a trigger element in the stream of speech and a context of the live video production at a time of receipt of the trigger element in the stream of speech.

Other aspects and features of embodiments may become apparent to those ordinarily skilled in the art upon review of the following description.

### BRIEF DESCRIPTION OF THE DRAWINGS

Example embodiments will now be described in greater detail with reference to the accompanying drawings.

FIG. 1 illustrates an example of a video production system.

FIG. 2 illustrates an example controller.

FIG. 3 is a flow diagram illustrating a method according to an embodiment.

FIG. 4 illustrates an example process flow.

FIG. 5 is a representation of a live video production output illustrating one example of voice control and its effect.

FIG. 6 is a representation of a live video production output illustrating a further example of voice control and its effect.

### DETAILED DESCRIPTION

The present disclosure refers primarily to control of live video production, which may also be described as control of a production environment, a production system, or production devices, for example. A live video production output is the result of a live video production, and may be referred to, for example, as a program output, live video, or a video stream.

A live video production refers to a production that is live in the sense that delays in production changes would be perceptible to a viewer of the production output. For example, a show may be recorded and produced live but broadcast at a later time, a live show that is produced in realtime may operate on a certain delay before being brought to air, or live segments that are recorded and produced live may be part of an edited production. Live production as referenced herein is not in any way restricted to immediate broadcast or distribution scenarios. Live shows are one example application of features disclosed herein, but such features may also or instead be used in other scenarios, including subsequent broadcast of an earlier recorded production, delayed live broadcast, live segments of an edited production, streaming, and so on.

Voice control is used herein to refer to control based on a person's voice. In embodiments herein, live video production control is responsive to a stream of speech, and may therefore also be referred to as speech control. A stream of speech refers to natural language as spoken by a speaker, rather than, for example, broken words or phrases that include only special terms or combinations that are specific to control. The speaker may be, for example, a production operator or a person on-air such as a host or presenter. Multiple speech streams received from different speakers may be monitored, so that control is not necessarily restricted to input from only one speaker. For example, some embodiments may support speaker identification. A “voiceprint” or sample of each speaker's speech may be captured and stored, to identify who a current speaker is. Speaker identity may be a further input for voice control.

For illustrative purposes, specific example embodiments will now be explained in greater detail below in conjunction with the figures.

The embodiments set forth herein represent information sufficient to practice the claimed subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

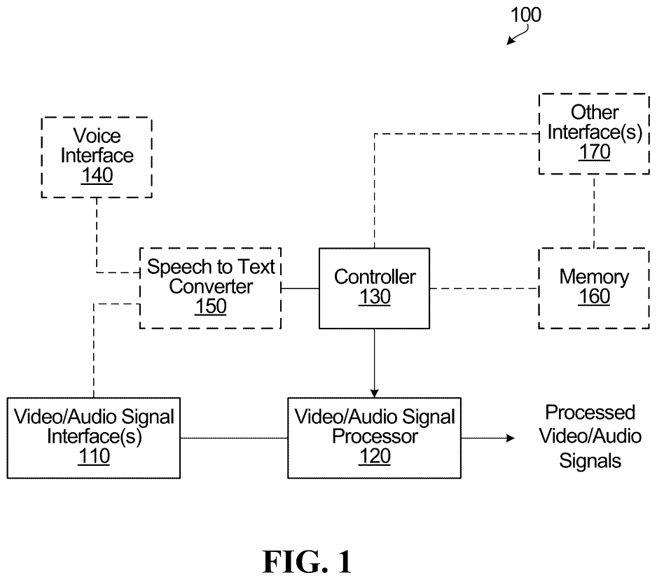

FIG. 1 illustrates an example of a video production system 100, which includes one or more video/audio signal interfaces 110, a video/audio signal processor 120, and a controller 130, coupled together as shown, and may also include a voice interface 140, a speech to text converter 150, a memory 160, and one or more other interfaces shown generally at 170. The example system 100 shown in FIG. 1, and similarly the contents of the other drawings, are intended solely for illustrative purposes. The present disclosure is in no way limited to the particular example embodiments explicitly shown in the drawings.

Video production, video production equipment, and video production control as referenced herein involve handling of video content but are not restricted to handling only video content. For example, a video production quite often involves not only video content, but also at least audio content and potentially other content such as graphic content and/or other types of content. Video signals, audio signals, combined video and audio signals, and other types of signals may be handled by video production equipment and used in a video production, and similarly a video production system may include video devices, audio devices, and/or other types of devices and sources of content. The video/audio signal interfaces at 110 and the video/audio signal processor 120 in FIG. 1 are intended to illustrate that a video production and video production equipment may involve other types of content such as (but not necessarily limited to) audio content. Put another way, a video production or video production equipment may involve or include audio and/or mixed content production or audio and/or mixed content production equipment.

It should also be appreciated that video signals, audio signals, and/or other signals that are involved in a video production or handled by video production equipment may include other information, such as data. For example, a video signal, an audio signal, or a combined video and audio signal may include data such as metadata related to the signal.

In general, hardware, firmware, components which execute software, or some combination thereof may be used in implementing any one or more (or all) of the illustrated components. Electronic devices that might be suitable for implementing these components include, among others, microprocessors, microcontrollers, Programmable Logic Devices (PLDs), Field Programmable Gate Arrays (FPGAs), Application Specific Integrated Circuits (ASICs), graphic processing units (GPUs) and other types of “intelligent” integrated circuits. For example, at least the video/audio signal processor 120 in FIG. 1 may be implemented in a GPU, and the controller 130 may be implemented in the same processing unit or a different processing unit. Either or both of such processing units, or more generally an electronic device that implements any component, may be configured for operation by executing computer-executable or processor-executable software stored in a non-transitory computer-readable or processor-readable memory. The memory 160 may be provided to store information such as trigger elements for control as described in further detail at least below, and may also store computer-executable or processor-executable software.

Such a memory may be implemented using one or more memory devices, which could include a solid-state memory device and/or a memory device with a movable or even removable storage medium. Multiple different types of memory devices could be used to implement such a memory. In an embodiment, a memory stores software for execution by one or more processors and/or other electronic devices, or more generally software for configuring either or both of the controller 130 or the video/audio signal processor 120 for operation. A memory could also or instead store other content, such as trigger elements, control actions, and/or information about live video production context as referenced herein.

A video/audio signal interface at 110, a voice interface 140, and/or other interface(s) at 170 may also or instead be implemented, at least in part, with one or more electronic devices that are configured for operation by executing software. At least these components also include physical devices or components that enable inputs to be received. These inputs are video/audio signals for a live video production in the case of a video/audio signal interface at 110, and voice inputs in the case of the voice interface 140. User inputs may be received from one or more users, through an operator console for example, in the case of the other interface(s) at 170. Examples of voice interfaces, user interfaces, and associated devices are provided at least below, and examples of video/audio signal interface devices include connectors, for video and/or audio cables for example, or other types of connections via which video/audio signals may be received for processing.

A microphone is an example of a voice input device that may be coupled to the voice interface 140 to provide speech inputs for voice control. The voice interface 140 is shown in dashed lines in FIG. 1, to illustrate that voice control could be, but need not necessarily be, implemented using a dedicated interface. For a live production, a host, commentator, or other on-air talent may provide streams of speech that are inputs to a live production and become part of that live production. Therefore, on-air speech may be monitored and used to control a live production, without adding an additional microphone or voice interface for control, and an interface to receive a stream of speech may then be in the form of a connection to an audio signal interface in a video production system, shown generally at 110 in FIG. 1.

Any of various types of inputs may be supported. A user interface at 170, for example, may include or be coupled to an interface device such as a keyboard to receive text input or more generally one or more key or button presses, and/or a graphical interface with an input device such as a touchscreen and/or a pointing or selection device such as a mouse, to receive graphical inputs. The interfaces at 170 are not necessarily limited to user interfaces. For example, one or more interfaces may be implemented to receive context information from one or more video devices that are controllable to change an aspect of a live video production, such as to bring content to air or to stop providing content. Another interface example is an interface to an intelligent device or system such as an artificial intelligence (AI) system or device that monitors an output of the live video production and provides current context information for context tracking. Multiple types of interfaces and inputs may be supported, in addition to speech inputs for voice control.

Turning now to operation of the example control equipment 100, an interface is provided to receive a stream of speech from a speaker. Such an interface may be or include a connection to receive the stream of speech from a video production system (a video/audio signal interface at 110 in the example shown in FIG. 1), in the case of speech input from an on-air person to enable on-air, live, realtime control of a live production, or a voice interface 140 to enable voice control of a live production by another person, such as a member of production crew. In the former example of on-air control, the received stream of speech is an audio input of the live video production, which gives on-air personnel direct control of at least certain aspects of a live production. In this example, the received stream of speech is related to the live video production in that it is an audio input of the live video production. In the latter example, a member of the production crew will be able to describe, in a natural language stream of speech, control actions that they wish to execute during a live video production, and such a stream of speech is also related to the live video production at least in the sense that it is intended to control the live video production.

In all of these examples, a stream of speech is received during a live video production, and is related in some way to that live video production. As described in further detail herein, such speech streams are actively monitored and used in live video production control.

The controller 130 may be coupled to an interface at 110 and/or the voice interface 140, directly or indirectly, and is implemented to generate and provide a control output, to the video/audio signal processor 120 in the example shown, to change an aspect of the live video production. The aspect of the live video production that changes as a result of the control output could include, for example, any one or more of the following:
adding a graphic component (an image or video) to an on-air output, immediately or with a transition effect;
removing a graphic component from an on-air output, immediately or with a transition effect;
adding an audio component to an on-air output, immediately or with a transition effect;
removing an audio component from an on-air output, immediately or with a transition effect.

As an example, consider removing and adding graphic components from an on-air output. An on-air presenter that wishes to switch from a weather graphic for one county to a weather graphic for another county may say something like “Let's clear this and now look at the weather for Washington County”. In this example, a first trigger element could be “clear this” and could match to a “clear” control action for the context of the current weather graphic, and “look at” could match to a control action to display a weather graphic of “Washington County” in the same state as the current weather graphic. With context-aware voice control as disclosed herein, the current on-air graphic can be automatically determined and cleared, with a subsequent transition to the Washington County weather graphic, in one fluid motion.

These control action examples are provided only for illustrative purposes. Other types of control actions may also or instead be supported for live video production control. The present disclosure is not limited to any particular types of control actions.

Spoken elements that may appear in a received stream of speech and trigger or initiate live video production changes are referred to herein as trigger elements. Trigger elements may be or include, for example, keywords or keyphrases. Control outputs and resultant changes in a live video productions are based not only on such trigger elements in received speech streams, but also on a context of the live video production at a time of receipt of a trigger element in a stream of speech. This dependency of control on both speech and context may be referred to as, for example, context-aware voice control, context-sensitive voice control, context-based voice control, or context-dependent voice control.

A live video production output of a context-aware voice-controlled live video production may be provided via an output interface of a production system such as a display, a video cable connector, a network connection, and/or a broadcast system interface, for example. In FIG. 1, a live video production output is shown as processed video/audio signals, which are output from a production system that includes the interfaces at 110 and the processor 120. An output interface may be coupled to or incorporated into the video/audio signal processor 120 in the example shown.

In some embodiments, a speech to text converter may be provided as shown at 150, and coupled to the interface through which the stream of speech is to be received. Such a converter is implemented to convert the stream of speech to a stream of text. A transcription engine is one example implementation of a speech to text converter. Speech to text conversion is an optional feature that may be provided in some embodiments. Other types of conversion or processing (including speech to speech conversion to convert between different speech formats and/or languages for example) may be applied to input speech streams, or there may be no such conversion or processing in embodiments that support control processing of speech. A Large Language Model (LLM), for example, may be suited to direct processing of speech for voice control, and more generally the controller 130 may be configured to process speech stream inputs without text conversion.

Other input processing may also or instead be implemented or supported. Although not shown in FIG. 1, a parser may be provided to parse words or phrases in speech or text, so that trigger elements can be identified by the controller 130. Parsing may be implemented separately, or supported by another element such as the speech to text converter 150 or the controller 130. In some embodiments, speech to text conversion and parsing are types of processing that are performed by the controller 130. The controller 130 may thus be configured to convert a received stream of speech to text, and/or to parse the received stream of speech into pieces of text for trigger element monitoring and detection.

A memory as illustrated in FIG. 1 may be coupled to the controller 130 as shown, and may store multiple trigger elements for which received speech streams are to be monitored. The controller 130 may be configured to monitor a received stream of speech for occurrence of any of the trigger elements (stored in the memory 160) in the stream of speech.

Another feature that may be supported in some embodiments is adaptability of the trigger elements for voice control. A user interface (or other interface) at 170, for example, may be coupled to the memory 160 to enable updating of stored trigger elements. Updating may include any one or more of the following, for example:
changing one or more of the trigger elements stored in the memory 160;
adding one or more trigger elements to those stored in the memory;
deleting one or more of the currently stored trigger elements from the memory.

More generally, one or more interfaces may be provided, and coupled to the memory 160 in the example shown, to enable updating of trigger elements. A user-modifiable (and/or otherwise-modifiable, by system or device updates for example) database of trigger elements may thus be provided and used in detecting trigger elements in received speech streams.

Trigger elements may, if relevant to live video production context, trigger control actions to change an aspect of a live video production. In some embodiments, the controller 130 is configured to match a detected trigger element to one or more of a number of possible control actions. The control actions may be stored in the memory 160 in the example shown, and in some embodiments trigger elements and control actions are stored in the same memory.

A user interface (or other interface) as shown by way of example at 170 may be coupled to the memory 160 to enable updating of stored control actions, for example to change one or more of the control actions stored in the memory, add one or more control actions to those stored in the memory, and/or delete one or more of the currently stored control actions from the memory. Thus, one or more interfaces may be provided, and coupled to the memory 160 in the example shown, to enable updating of control actions, to thereby provide a user-modifiable (and/or otherwise-modifiable, by system or device updates for example) database of control actions to enable matching of trigger elements that are detected in received speech streams to candidate control actions. The control actions are referred to as candidate control actions at this stage of control because these control actions might not necessarily be triggered by the detected trigger elements and result in a control output, unless they are relevant to production context.

Context-aware voice control may be supported by configuring the controller 130 to provide a control output based on relevance of any matched control actions to the live video production context. For example, the controller may be configured to provide a control output based on any matched control action that has relevance to the context. Control actions are matched to detected trigger elements, and accordingly at least in this sense control action relevance to context is also related to relevance of the detected trigger element to the context.

A significant potential benefit of context awareness as disclosed herein is reduction or avoidance of ambiguity in inputs, and associated control delays. For example, relevance may be determined based on location or geography, such as for a live report on sports, news, or weather. Different towns or cities may have some of the same street names, and different countries, states, or provinces may have some of the same town, city, or county names, which may cause ambiguity if a street, town, city, or county name is provided as a voice control input. Without context awareness to resolve ambiguity in control inputs, a control input could be ignored, an error may be generated, or a production crew member may need to resolve the ambiguity. As an example, suppose that natural language transcription with keyword matching were implemented, without context awareness, to trigger production commands. A voice input referring to “Washington County” might be correctly detected based on keyword matching, but is ambiguous in light of the fact that the county name does not allow for differentiation between Washington County, New York and Washington County, Pennsylvania.

This is just one example of the same county name in multiple states. The issue is much more extensive, even just for county-level ambiguity in the United States alone, where there are thousands of counties distributed among 50 states. At the city, town, or street level, or in respect of locations that span multiple countries, geographic ambiguity presents an even larger challenge. Although such ambiguities may be resolved by operator intervention, it is impractical for an operator to manually locate and make correct content such as graphics available in response to an analyst's spontaneous commentary during a live broadcast or other live video production, for example.

In embodiments herein, the controller 130 may be configured to track context of the live video production, for determining whether a trigger element that is detected in a stream of speech (or a control action that is matched to a detected trigger element) has relevance to the context. In the example above, if the state of New York were displayed in an on-air current weather graphic when “Washington County” is spoken on air or in a control room, then Washington County in New York may be determined as having relevance, whereas Washington County in Pennsylvania may be determined as lacking relevance to this particular context of the live video production. In this example, Washington County is recognized as a trigger element, and control is based on both the Washington County trigger element and the context of New York (and not Pennsylvania, which is not relevant to the live video production context).

Any of various options may be implemented to keep track of context. In one embodiment, the controller 130 is configured to track context of the live video production using a state machine.

State machine maintenance, or more generally context tracking, may be enabled in any of various ways. For example, one or more interfaces may be provided, and coupled to the memory 160 in the example shown in FIG. 1, to enable updating of context of a live video production. A user interface (or other interface) as shown by way of example at 170 may be coupled to the memory 160 to enable updating of stored context information during the live video production. Production output changes as a result of control outputs from the controller 130, which changes current context. In the case of context updates, although user updates may be supported, automated updating may be preferred. Controlled video devices, for example, may provide context updates or be monitored to provide context updates as their operating conditions change. An AI system or device, or other monitoring system or device, may monitor a production output and provide context updates. Other types of monitoring or sensing to track context may also or instead be supported, such as to track position(s) of on-air personnel on a set or at a filming location, set or filming location conditions such as weather, and so on.

Context information may be updated, and this may involve maintaining a state machine in some embodiments, by receiving updates from one or more update sources. Update sources may include, for example, one or more AI systems and/or other production devices, for example. Other examples of update sources for context updating are also provided herein.

In general, one or more interfaces may be provided, and coupled to the memory 160 in the example shown, to enable updating of the context of a live video production, to thereby provide a user-modifiable (and/or otherwise-modifiable, by system or device updates for example) context database or record.

Context, and relevance, may be in tracked and determined in respect of any of various parameters or characteristics, such as any one or more of the following:
a graphic that is on air, which may be tracked via context updates provided by graphic devices that provide graphics for example;
an effect (such as a lighting effect) that is active, which may be tracked via context updates provided by effects devices that provide effects for example;
a camera that is on air, which may be tracked via context updates provided by cameras for example;
a position of a person on a set or filming location, which may be tracked via context updates provided by sensors for example;
a position of an object on a set or at a filming location, which may be tracked via context updates provided by sensors for example;
set or filming location conditions, which may be tracked via context updates provided by sensors for example;
status of a content source;
data provided by one or more data sources;
a current geographic focus;
active visual elements in a production output;
one or more timing aspects such as time of day;
an interface such as an application programming interface (API) externally being triggered by other production equipment;
content on a particular production equipment output interface;
identity of a speaker of an input speech stream in which a trigger element is detected;
operating parameters of video production equipment or one or more components of video.

In these examples, a content source refers to a source of content, and that content may be or include, for example, any one or more of: video, audio, graphics, other content types. Examples of status of a content source include a video source that is currently on air, and whether a particular piece of video production equipment is contributing to an on air output or other production output.

Data sources may include any of various types of data sources, such as data sources that provide any one or more of the following, for example:
statistics and/or other data relevant to a sports broadcast;
a current and/or forecast weather feed for a weather broadcast;
camera and/or other object tracking data;
tally data and/or other data sourced from inside or outside the production environment;
data related to status (such as health) of the production environment or any part thereof, for example if a graphics computer A is offline then control can contextually pass the workload to another graphics computer B);
data inferred from processing (such as artificial intelligence/machine learning (AI/ML) processing for example) of current and/or historical information that relevant to the production.

In the above examples, tally data refers to data that can be obtained from video switchers and/or other video equipment or devices, from which the video sources that are currently online can be determined. This data provides information on the operational state of video sources, enhancing situational awareness and supporting the application of logic for more informed decision-making. Tally data is an example of supplemental data that can inform system context and state.

Operating parameters as referenced in the examples above may be or include, for example, equipment or device conditions or settings such as orientation and/or zoom of a camera, which may be reported for context updating by the video production equipment or component(s).

These context and context tracking examples are provided solely for illustrative purposes. Other types or properties of a production may also or instead be tracked as context for control purposes, and/or context may be tracked in other ways. The present disclosure is not limited to any particular types of context or context tracking.

Trigger elements may also take any of various forms, and may include any one or more of the following, for example:
a geographic reference (such as a street, town, city, county, or country name);
a time reference (for example a relative time such as “2 hours later” or “2 hours before” to update a pre-recorded image or video with a corresponding image or video at a different time relative to the pre-recording time as opposed to a local current time);
an identity (for example a team name, or a name such as the surname of a player where opposing teams have a player with the same surname but only one of those players is on a team for which a goal, penalty, or other event is being replayed);
an event descriptor, such as a reference to breaking news, or a reference to a goal, a penalty, or an injury during a sports game.

These trigger element examples are also provided only for illustrative purposes. Other types of trigger elements may also or instead be detected for live video production control. The present disclosure is not limited to any particular types of trigger elements.

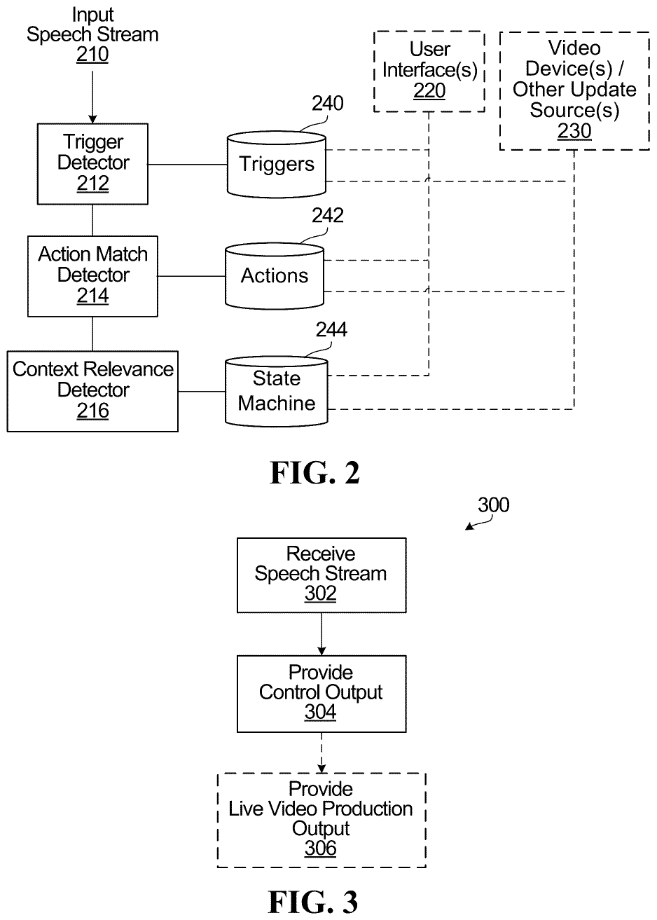

With reference now to FIG. 2, an example controller is shown. The example controller includes a trigger detector 212, an action match detector 214, and a context relevance detector 216, interconnected as shown. A trigger database 240, an actions database 242, and a state machine 244 for context tracking are also shown in FIG. 2 as being coupled to the trigger detector 212, the action match detector 214, and the context relevance detector 216, respectively. The trigger database 240, the actions database 242, and the state machine 244 may be stored in the memory 160 in FIG. 1, for example. One or more user interfaces are shown at 220 and one or more interfaces to video device(s) and/or other update sources are shown at 230 as being coupled to the trigger database 240, the actions database 242, and the state machine 244, to support any of various types of trigger element/action updating and context tracking. The interface(s) at 220 and 230 are examples of the interface(s) 170 in FIG. 1, and may include one or more interfaces that are also or instead coupled to the controller components in FIG. 2 (the trigger detector 212, the action match detector 214, and the context relevance detector 216). Connections between the interface(s) and the controller components are not shown in FIG. 2, to avoid further congestion in the drawing.

The trigger detector 212, the action match detector 214, and the context relevance detector 216 may be implemented in any of various ways, and the example implementations provided herein for the controller 130 also apply to these controller components in FIG. 2.

The trigger detector 212 supports trigger element detection. A controller such as the controller 130 in FIG. 1 may include the trigger detector 212 to receive and monitor the stream of speech, shown as an input speech stream 210 in FIG. 2, for occurrence of any of multiple trigger elements in the stream of speech. The trigger elements are stored in the triggers database 240 in the example shown in FIG. 2, and one or more of the interface(s) at 220 and/or 230 may enable updating of the store trigger elements.

The action match detector 214 supports matching of a detected trigger element to a control action. A controller such as the controller 130 in FIG. 1 may include the action match detector 214 to receive and match a detected trigger element to one or more of multiple control actions. The control actions are stored in the actions database 242 in the example shown in FIG. 2, and one or more of the interface(s) at 220 and/or 230 may enable updating of the stored control actions.

The context relevance detector 216 supports assessment of relevance of one or more candidate control actions (that are matched to a detected trigger) to production context. A controller such as the controller 130 in FIG. 1 may include the context relevance detector 216 to provide a control output based on any of the one or more candidate control actions that have relevance to the context of the live video. Context information is tracked using a state machine and the database 244 in the example shown in FIG. 2, and one or more of the interface(s) at 220 and/or 230 may enable updating of the stored context information.

Although embodiments herein focus primarily on control, control equipment may be deployed in conjunction with, or even be integrated with, video production equipment. A video production system, for example, may include video production control equipment as disclosed herein, and video production equipment, coupled to and controlled by the video production control equipment, to provide a live video production output of the live video production.

Embodiments are not limited to equipment embodiments. Other embodiments, such as method embodiments, are also possible.

FIG. 3 is a flow diagram illustrating a method according to an embodiment. The example method 300 involves receiving, during a live video production, a stream of speech that is related to the live video production, as shown at 302. The example method 300 also involves providing a control output, as shown at 304, to change an aspect of the live video production. The control output that is provided at 304 is based on a trigger element in the stream of speech and a context of the live video production at a time of receipt of the trigger element in the stream of speech. The example method 300 relates primarily to control, but in some embodiments a method may also involve providing a live video production output of the live video production, as shown at 306.

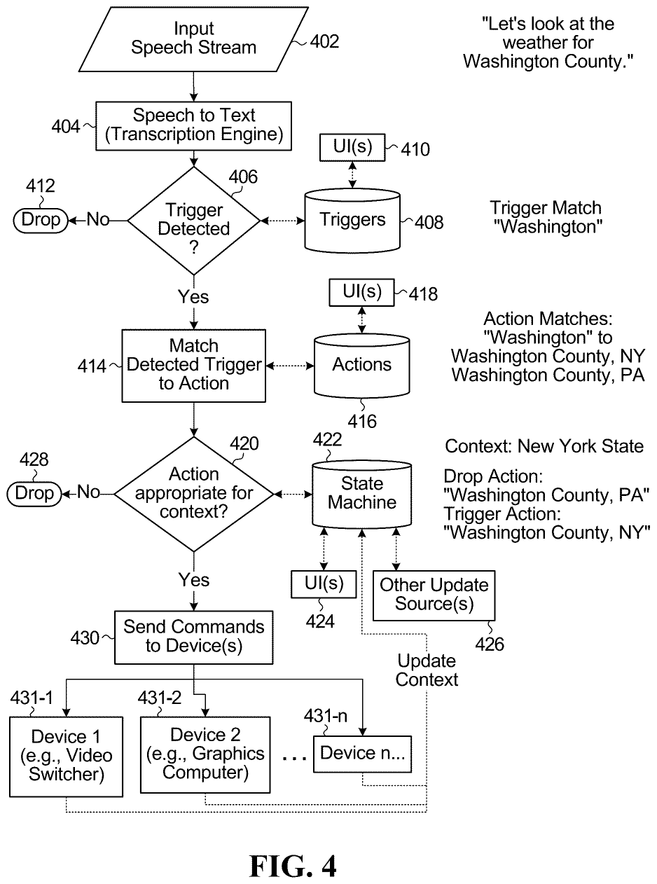

Method embodiments may involve other features disclosed herein, and/or performing operations in any of various ways. FIG. 4 illustrates an example process flow, and such features and operations are described by way of example below with reference to FIG. 4. FIG. 4 shows the control flow, where trigger elements are processed through detection (“Trigger Detected?”) at 406, action matching (“Match Detected Trigger to Action”) at 414, and context filtering (“Action appropriate for context?”) at 420. This control flow is described in further detail below.

An input speech stream 402 is shown at the top of FIG. 4, and in some embodiments may be or include an audio input of the live video production.

Converting the stream of speech to a stream of text is also illustrated in FIG. 4, and a transcription engine 404 is provided as an implementation example of the speech to text conversion.

Trigger detection in FIG. 4 at 406 may involve monitoring the stream of speech for occurrence of any of multiple trigger elements in the stream of speech. Some embodiments may support updating the trigger elements, and a user-updateable database of trigger elements is shown by way of example in FIG. 4 at 408. The stored trigger elements may be updated via one or more user interfaces 410 in the example shown. As shown in FIG. 2 and described at least above, trigger element updates are not limited to user updates. Other interfaces are not shown for the trigger element databased in FIG. 4 in order to avoid further congestion in the drawing.

Although a trigger element database 408 is shown as an example in FIG. 4, embodiments are not restricted to trigger element matching (such as keyword or keyphrase matching) in a trigger database. For example, a Large Language Model (LLM) may instead be used to determine whether parts of an input speech stream sufficiently match a trigger element, based on the meaning of the received speech stream or contextual matching. This LLM example illustrates not only that trigger element detection need not necessarily involve a memory lookup, but also that trigger element detection is not limited to exact matching. Trigger element detection may be based on contextual matching, partial matching, or a certain degree or threshold of matching between an input speech stream and a trigger element, for example. These matching examples also illustrate additional logic or features that may be provided or supported in some embodiments, and applied to inputs and/or processing to extend functionality. Here, the examples relate to extending trigger element detection beyond exact matching, and other examples of additional logic or features are also provided at least below.

If no trigger element is detected in the received input speech stream, then the stream (or converted text) is dropped from further control processing as shown at 412, or may be stored for another purpose, such as to update current production context. Processing of a detected trigger element proceeds, in the example shown, with matching a detected trigger element to one or more control actions at 414. Such matching may involve, for example, searching a control actions database 416 to control actions that are associated with a detected trigger element. A method may involve updating the control actions, and the example in FIG. 4 illustrates a user-updateable database of control actions. Although one or more UI(s) are shown at 418 in FIG. 4, the stored control actions may also or instead be updated in other ways, via other interfaces such as shown in FIG. 2 and described at least above, for example. In order to avoid further congestion in FIG. 4, other interfaces are not shown for updating the stored control actions.

Next, the example shown in FIG. 4 includes determining whether a candidate control action that is matched to a detected trigger element is appropriate for (also referred to herein as relevant to) the production context, at 420. A state machine 422 is shown in FIG. 4, and is illustrative of an embodiment in which tracking production context involves using a state machine. Maintaining a state machine may involve updating context (by updating stored context information such as a current state, for example). A method may involve receiving context updates from one or more update sources, to maintain a state machine for example. Examples of update sources are provided elsewhere herein, and updates from one or more UI(s) 424, device(s) 432-1, 432-2, 432-n, and other update source(s) 426 are shown as examples in FIG. 4.

Control action relevance to context may be detected or determined by a controller or a component thereof, such as the context relevance detector 216 in FIG. 2, which may implement or include a logical component such as a context engine. A relevance determination or detection may be described as determining whether a candidate control action is appropriate for or relevant to the current context or “state” of the live video production when a trigger element is received in the input speech stream.

A state machine 422, or more generally context tracking, may support features beyond tracking of a limited number or limited types of states, to support more complex determinations as to control action relevance. For example, context tracking need not be limited to a state machine or other implementation that is able to provide only limited indications such as “current state x” or “current context y”. More detailed information related to context may also be provided, to further define or characterize current context of a production and enable more in-depth assessment of control action relevance. Additional configurations or logic to support such features may be stored in (or with) a state machine database, and may be user (or otherwise) editable to enable adaptation of control action relevance assessment.

In some embodiments, a state machine, a controller, and/or another component such as a context engine, may support more complex context-based processing to determine whether a downstream command (more generally, a control output) is to be sent, and if so, which one(s). Such features may be enabled, for example, by implementing logic, which may be customizable or adaptable, through configuration by a user for example. In FIG. 4, the state machine UI(s) 424 may include a UI to enable user configuration of context processing. Context logic may also or instead be automatically updateable from any of various other sources.

As a simple example, a user may be able to create logic to implement the following: Trigger element (“Play Video”)->If Camera 1 is on air, send (“Play” command to video server 1), If Camera 2 is on air, send (“Play” command to video server 2).

In more general terms, context logic may be expressed as follows: “Trigger Element”->Logic->Which command (control output) to send and where (or not to send any). The Logic (and/or the Trigger Element and/or the command (control actions)) in this example may be created by a user, based on any of various information streams that are provided to control equipment or a component thereof such as a controller. Trigger elements may be configured based on keywords or keyphrases that are expected to be spoken to initiate certain control actions, context processing may be configured based on context information to which control equipment has access, and the control actions and context processing logic may be configured based on how available context information is to impact production control.

These logic examples are illustrative of how relevance may be determined based on configurable relevance determination parameters, for the context processing or logic referenced above. In a method embodiment, for example, providing a control output based on a detected trigger element and context of the live video production may involve determining the relevance of one or more control actions to the context based on configurable relevance determination parameters. Some embodiments may also involve configuring the relevance determination parameters.

If it is determined that a candidate control action is not relevant to production context, then the control action is dropped in this example, as shown at 428. A candidate control action that is determined to be relevant to the production context is triggered or initiated, and results in a command being sent (at 430) to one or more devices 432-1, 432-2, 432-n of a video production system in the example shown. This illustrates an example of how providing a control output based on a detected trigger element and context of a live video production may involve providing the control output based on relevance of the one or more control actions (and accordingly the detected trigger element to which the control actions are matched) to the context of the live video production.

A command as shown at 430 in FIG. 4 is an example of a control output that may be provided to control an aspect of a live video production. A video switcher, shown in FIG. 4 as an example of a device 432-1 of a production system, may be controlled to change one or more inputs, effects, and/or other processing used in generating a production output. A graphics computer, shown in FIG. 4 as another example of a device 432-2 of a production system, may be controlled to add graphics to and/or remove graphics from a production output. A production system may include any number of controllable devices (a number n in the example shown in FIG. 4), and a control output may control any one or more of such devices.

A control output is one of a number of conditions or factors that may change the production context, and FIG. 4 illustrates controlled devices 432-1, 432-2, 432-n as updating production context in the state machine 422. This is related to one example of tracking context of a live video production, by receiving updates from one or more devices of a video production system. User updates are also illustrated in FIG. 4, in the form of one or more UI(s) 424. One or more other update sources 426 may also be supported, to monitor and update other conditions or parameters of a production such as positions and/or conditions on a set or at a filming location.

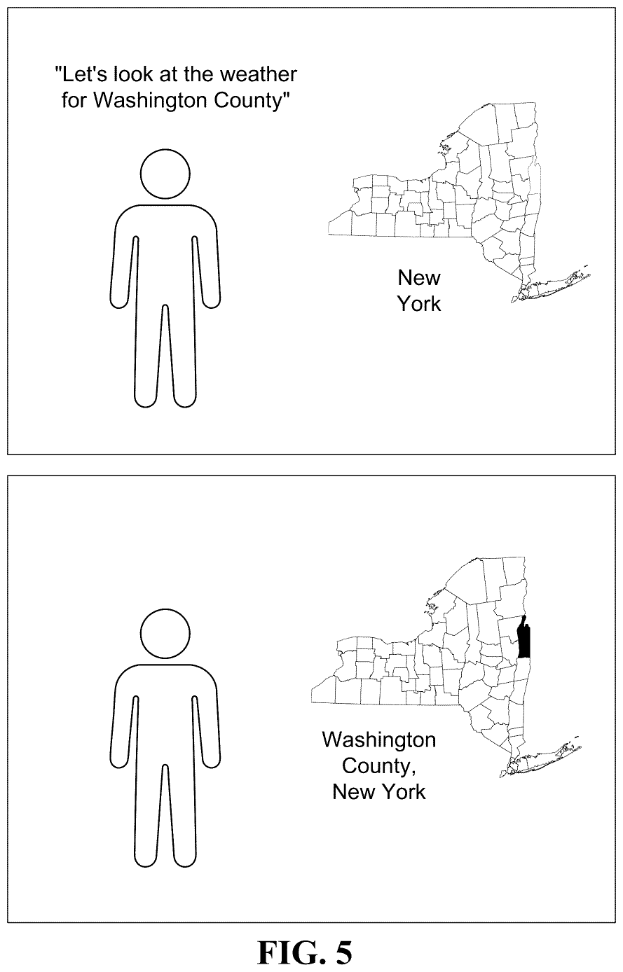

Text entries at the right in FIG. 4 are provided as an example to help illustrate control flow in FIG. 4. FIG. 5 is a representation of a live video production output illustrating this example of voice control and its effect.

With reference first to FIG. 5, in the example production output as shown at the left, the context is a weather map of New York state. The on-air host in this example speaks the speech stream as shown: “Let's look at the weather for Washington County.” The corresponding trigger match in FIG. 4 is on the keyword “Washington”, and candidate control actions match the detected trigger element “Washington” to Washington County, NY and Washington County, PA in the example shown. Other candidate control actions may similarly be matched, but for this example only two candidate control actions are shown.

Based on the context of New York State in the current output at the top in FIG. 5, only the Washington County, NY control action is determined to be relevant. The Washington County, PA control action is dropped, and the Washington County, NY control action is triggered, as shown at the right in FIG. 4. A command is sent to one or more devices of a live video production system that is generating the output, and the result is as shown at the bottom in FIG. 5, with Washington County, NY now highlighted. This highlighting of Washington County, NY in the output avoided manual intervention to resolve the ambiguity in the trigger element/control action match to two control actions. The control output and the resultant change in the production output are in realtime or near-realtime after the speech stream that included a trigger element was spoken, with a much smaller delay relative to manual intervention or control.

FIG. 5 thus provides an example of context-based disambiguation, showing how “Washington” matches to Washington County, NY based on the New York state context.

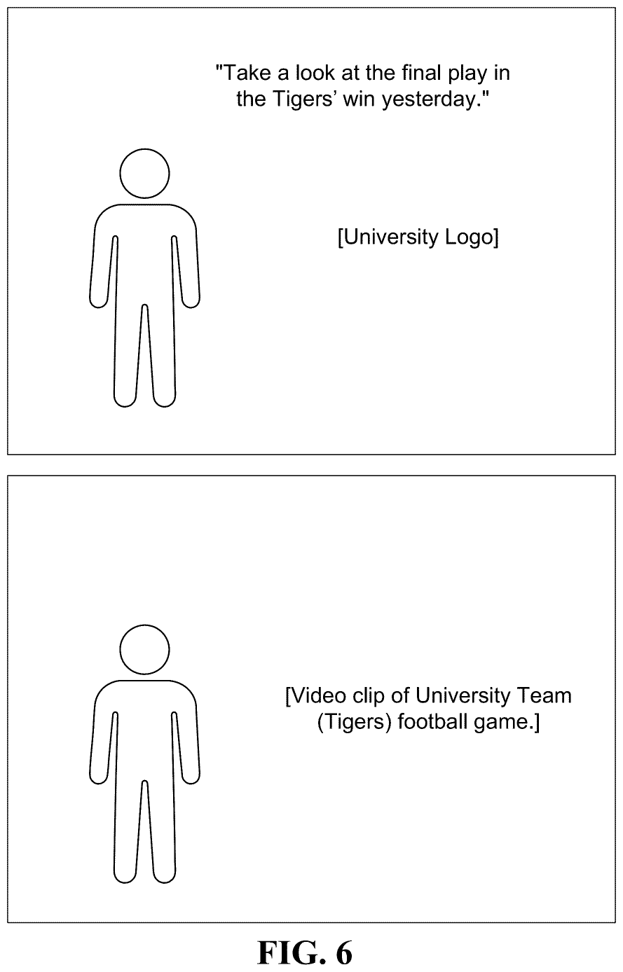

FIG. 6 is a representation of a live video production output illustrating a further example of voice control and its effect. In FIG. 6, current context of a newscast or sportscast relates to a university, and a university logo is currently on-air as shown at the top in FIG. 6. The host speaks the speech stream as shown, referencing the name of a sports team, “Tigers”. For the purpose of this example, suppose that “Tigers” is a trigger element, but that there are multiple matched control actions based on tigers (the animal) and different Tigers sports teams. Within the production context of a particular university, only one of the candidate control actions has relevance, and a command is sent to a video production system to add a video clip of the correct “Tigers” team recent football game as shown at the bottom in FIG. 6.

FIG. 6 thus illustrates how context-aware voice control enables differentiation of “Tigers” team references, filtering out irrelevant “Tigers” mentions that may be part of a set of trigger elements.

FIGS. 5 and 6 are very simple examples, and the present disclosure is not in any way limited to such examples. Control actions and changes to production outputs may be much more substantial than highlighting a county as in FIG. 5 or switching from a logo to a related video clip in FIG. 6.

More complex control flows and processing are also possible. For example, triggering elements, control actions, and context information may be determined and configured/updated to support any desired level of specificity or granularity in live video production control.

Other features may also or instead be provided in embodiments. For example, control may be based on inputs other than only speech streams. Manual triggers, such as API commands or button pushes, for example, may be provided as control inputs and then processed for context relevance for context-aware manual control.

Interaction with external devices or systems may be provided in some embodiments. For example, some embodiments may support manual control of an API and/or systems or devices that use an API. Stored trigger elements, control actions, and/or context information may be exposed to and/or potentially updated by other systems or devices via the same (or another) API. A bi-directional API may be especially preferred to allow for expansion of a control system, for example.

Voice control as disclosed herein may encompass embodiments in which control, or a controller for example, uses states (context information) that may be user-defined, speech stream inputs, and trigger element detection that may be based on keywords, keyphrases, or intent in the case of contextual or LLM-based detection for example. Control processing (logic, for example), which may also or instead be configurable, may be applied to these inputs and the states, and potentially other items or information that a user may wish to add, and a resultant control output provides context-aware control. Context updates may be provided as input, to a state machine for example, for tracking context (by changing state in the case of a state machine), and other inputs (also referred to herein as update sources) may also or instead be used in context tracking.

Various embodiments are disclosed herein, primarily in the context of processing control equipment and methods. Other embodiments are also possible.

For example, at least functional features may be embodied as computer-executable or processor-executable instructions stored on one or more non-transitory computer-readable or processor-readable storage media. Such instructions, when executed by one or more computers or one or more processors, cause the computer(s)/processor(s) to perform functions or operations disclosed herein, to support features disclosed herein, or to perform a method as disclosed herein.

A non-transitory processor-readable medium according to one embodiment stores instructions which, when executed by a processor, cause the processor to: receive, during a live video production, a stream of speech that is related to the live video production; and provide a control output to change an aspect of the live video production based on a trigger element in the stream of speech and a context of the live video production at a time of receipt of the trigger element in the stream of speech. More generally, a non-transitory processor-readable medium may store instructions which, when executed by a processor, cause the processor to perform any method disclosed herein.

What has been described is merely illustrative of the application of principles of embodiments of the invention. Other arrangements and methods can be implemented by those skilled in the art without departing from the scope of the present invention. For example, features disclosed herein in the context of any particular embodiments may be provided in other embodiments.

As another example, the division of functions as shown in FIGS. 1 and 2 are intended solely for illustrative purposes. Embodiments may be implemented with fewer, additional, and/or different components than those explicitly shown. Similarly, a method may include fewer, additional, and/or different operations than those explicitly shown in FIGS. 3 and 4.

Application of the features herein is also not in any way limited to particular types of productions. Embodiments may be of benefit in weather segments, for example, so that meteorologists would no longer be limited to a preset, linear progression of weather graphics, and may use natural language to change between graphics in their segments, in any order and in realtime. Similarly, for sports shows or segments, hosts or analysts could trigger their own content such as replays, highlights, and/or sound effects, without waiting for a producer in a control room. For news segments, as hosts or analysts discuss past or current events, context-aware searches could be running in the background for applicable video footage, including previously unused “b-roll” footage, and offer that footage for producers to choose to show via manual input that could also be processed for relevance to production context as disclosed herein.

1. Video production control equipment comprising:
an interface to receive, during a live video production, a stream of speech that is related to the live video production;
a controller, coupled to the interface, to provide a control output to change an aspect of the live video production based on a trigger element in the stream of speech and a context of the live video production at a time of receipt of the trigger element in the stream of speech.

2. The video production control equipment of claim 1, wherein the stream of speech comprises an audio input of the live video production.

3. (canceled)

4. The video production control equipment of claim 1, wherein the controller is configured to monitor the stream of speech for occurrence of any of a plurality of trigger elements in the stream of speech.

5. (canceled)

6. The video production control equipment of claim 4, further comprising:
a memory, coupled to the controller, storing the plurality of trigger elements;
one or more interfaces, coupled to the memory, to enable updating of the trigger elements.

7. The video production control equipment of claim 1, wherein the controller is configured to match the trigger element to one or more of a plurality of control actions.

8. (canceled)

9. The video production control equipment of claim 7, further comprising:
a memory, coupled to the controller, storing the plurality of control actions;
one or more interfaces, coupled to the memory, to enable updating of the control actions.

10. The video production control equipment of claim 7, wherein the controller is configured to provide the control output based on relevance of the one or more control actions to the context of the live video production.

11. (canceled)

12. The video production control equipment of claim 10, wherein the relevance is determined based on configurable relevance determination parameters.

13. The video production control equipment of claim 1, wherein the controller is configured to track context of the live video production.

14-15. (canceled)

16. The video production control equipment of claim 13, further comprising:
one or more interfaces to enable updating of the context of the live video production.

17-18. (canceled)

19. A video production system comprising:
the video production control equipment of claim 1; and
video production equipment, coupled to the video production control equipment, to provide a live video production output of the live video production.

20. A method comprising:
receiving, during a live video production, a stream of speech that is related to the live video production;
providing a control output to change an aspect of the live video production based on a trigger element in the stream of speech and a context of the live video production at a time of receipt of the trigger element in the stream of speech.

21. The method of claim 20, wherein the stream of speech comprises an audio input of the live video production.

22. (canceled)

23. The method claim 20, further comprising:
monitoring the stream of speech for occurrence of any of a plurality of trigger elements in the stream of speech.

24. The method of claim 23, further comprising:
updating the trigger elements.

25. The method of claim 20, further comprising:
matching the trigger element to one or more of a plurality of control actions.

26. The method of claim 25, further comprising:
updating the control actions.

27. The method of claim 25, wherein providing the control output based on the trigger element and the context of the live video production comprises providing the control output based on relevance of the one or more control actions to the context of the live video production.

28. The video production control equipment of claim 27, wherein providing the control output based on the trigger element and the context of the live video production comprises:
determining the relevance based on configurable relevance determination parameters.

29. The method of claim 20, further comprising:
tracking context of the live video production.

30-31. (canceled)

32. The method of any one of claim 29, further comprising:
updating of the context of the live video production.

33-34. (canceled)

35. The method of claim 20, further comprising:
providing a live video production output of the live video production.

36. A non-transitory processor-readable medium storing instructions which, when executed by a processor, cause the processor to:
receive, during a live video production, a stream of speech that is related to the live video production;
provide a control output to change an aspect of the live video production based on a trigger element in the stream of speech and a context of the live video production at a time of receipt of the trigger element in the stream of speech.

37. (canceled)
